(19) United States
(12) Patent Application Publication
(10) Pub. No.: US 2026/0087524 A1
(43) Pub. Date: Mar. 26, 2026

(54) ADVERTISEMENT GENERATION SYSTEM, ADVERTISEMENT GENERATION METHOD, AND NON-TRANSITORY COMPUTER READABLE MEDIUM

(71) Applicant: NEC Corporation, Tokyo (JP)

(72) Inventors: Rui KONDO, Tokyo (JP); Yasuhiko YOSHIDA, Tokyo (JP); Kazuma KUNIYOSHI, Tokyo (JP); Shinnosuke NISHIMOTO, Tokyo (JP)

(73) Assignee: NEC Corporation, Tokyo (JP)

(21) Appl. No.: 19/324,397

(22) Filed: Sep. 10, 2025

(30) Foreign Application Priority Data
Sep. 26, 2024 (JP) 2024-167139

(51) Int. Cl. G06Q 30/0241; G06Q 30/0273; G06T 13/20; G06T 19/00; G06T 19/20

(52) U.S. Cl. CPC G06Q 30/0276; G06Q 30/0273; G06T 13/20; G06T 19/003; G06T 19/20; G06T 2219/024; G06T 2219/2004

(57) ABSTRACT

An object is to provide an advertisement generation system capable of more easily setting an advertisement in a virtual space. An advertisement generation system includes a selection unit that selects an advertisement providing place in a virtual space, an input reception unit that receives an input of a parameter for setting an advertisement providing mode, and a generation unit that generates the advertisement based on the providing place and the parameter.

### INCORPORATION BY REFERENCE

This application is based upon and claims the benefit of priority from Japanese patent application No. 2024-167139, filed on Sep. 26, 2024 the disclosure of which is incorporated herein in its entirety by reference.

### TECHNICAL FIELD

The present disclosure relates to an advertisement generation system, an advertisement generation method, and a non-transitory computer readable medium.

### BACKGROUND ART

A technique for generating an advertisement of a product or a service based on a condition designated by an advertiser is known. As a related technology, JP 2002-032506 A discloses a recruitment advertisement creation system including: a recruitment condition input unit configured to input a recruitment condition; a recruitment advertisement creation unit configured to create a recruitment advertisement conforming to the recruitment condition; and a recruitment advertisement output unit configured to transmit the created recruitment advertisement to a recruitment advertisement posting medium.

### SUMMARY

In recent years, a service for providing a virtual space constructed by a computer to a user has been known. The user can operate an avatar moving in a virtual space as his/her virtual self to move in the virtual space or to talk with other avatars. The user may receive, via the avatar, a service provided in the virtual space.

Efforts have been made to provide advertisements in the virtual space. For example, an advertiser can provide an advertisement to a user who visits a bulletin board by posting the advertisement on the bulletin board installed in the virtual space. However, with the technique disclosed in JP 2002-032506 A, there is a possibility that an advertiser cannot easily set an advertisement.

In view of the above-described problems, an example object of the present disclosure is to provide an advertisement generation system, an advertisement generation method, and a program capable of more easily setting an advertisement in a virtual space.

An advertisement generation system according to one example aspect of the present disclosure includes
a selection unit that selects an advertisement providing place in a virtual space,
an input reception unit that receives an input of a parameter for setting an advertisement providing mode, and
a generation unit that generates the advertisement based on the providing place and the parameter.

An advertisement generation method according to one example aspect of the present disclosure includes
selecting an advertisement providing place in a virtual space,
receiving an input of a parameter for setting an advertisement providing mode, and
generating an advertisement based on the providing place and the parameter.

A program according to one example aspect of the present disclosure, causing a computer to execute
selecting an advertisement providing place in a virtual space,
receiving an input of a parameter for setting an advertisement providing mode, and
generating the advertisement based on the providing place and the parameter.

In an example of the effects of the advertisement generation system, the advertisement generation method, and the program according to the present disclosure, it is possible to more easily set an advertisement in a virtual space.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an advertisement generation system according to the present disclosure;

FIG. 2 is a flowchart illustrating processing of the advertisement generation system according to the present disclosure;

FIG. 3 is a block diagram illustrating an overall configuration of an advertisement system according to the present disclosure;

FIG. 4 is a block diagram illustrating a configuration of the advertisement generation system according to the present disclosure;

FIG. 5 is a view illustrating an example in which the providing place is selected based on the number of visual lines of a user;

FIG. 6 is a diagram illustrating an example of selecting the providing place based on the number of visual lines of the user;

FIG. 7 is a view illustrating an example of a display screen for selecting an advertisement providing place and an advertisement type according to the present disclosure;

FIG. 8 is a diagram illustrating an example of an advertisement providing mode according to the present disclosure;

FIG. 9 is a flowchart illustrating processing of the advertisement generation system according to the present disclosure; and

FIG. 10 is a block diagram illustrating a hardware configuration of a computer that implements the advertisement generation system and the like according to the present disclosure.

### EXAMPLE EMBODIMENTS

Hereinafter, example embodiments of the present disclosure will be described in detail with reference to the drawings. In the drawings, the same or related elements are denoted by the same reference signs. For clarity of description, redundant description will be omitted as necessary.

### First Example Embodiment

### Advertisement Generation System 100

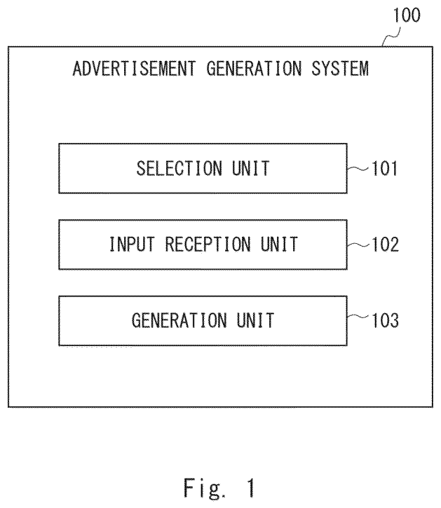

FIG. 1 is a block diagram illustrating a configuration of an advertisement generation system 100 according to the present disclosure. The advertisement generation system 100 includes a selection unit 101, an input reception unit 102, and a generation unit 103.

The selection unit 101 selects an advertisement providing place in a virtual space. The input reception unit 102 receives an input of a parameter for setting an advertisement providing mode. Hereinafter, the advertisement providing place may be simply referred to as “providing place”. Hereinafter, the parameter for setting the advertisement providing mode may be simply referred to as a “parameter”. The generation unit 103 generates an advertisement based on the providing place and the parameter.

The advertisement generation system 100 includes a processor, a memory, and a storage device as components (not illustrated). The storage device stores a computer program in which the processing according to the present disclosure is implemented. The processor causes the computer program to be read from the storage device into the memory, and is capable of executing the computer program. As a result, the processor implements the functions of the selection unit 101, the input reception unit 102, and the generation unit 103.

Alternatively, each of the selection unit 101, the input reception unit 102, and the generation unit 103 may be achieved by dedicated hardware. A part or all of components may be achieved by a general-purpose or dedicated circuitry, a processor, or the like, or a combination thereof. Those components may be configured by a single chip, or may be configured by a plurality of chips connected via a bus. Some or all of the components may be achieved by a combination of the aforementioned circuitries or the like and the program.

### Processing of Advertisement Generation System 100

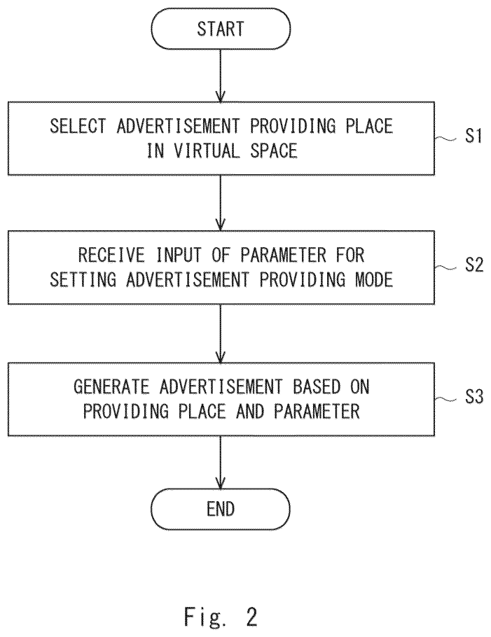

Processing performed by the advertisement generation system 100 will be described with reference to FIG. 2. FIG. 2 is a flowchart illustrating processing of the advertisement generation system 100.

First, the selection unit 101 selects an advertisement providing place in a virtual space (S1). Next, the input reception unit 102 receives an input of a parameter for setting an advertisement providing mode (S2). Then, the generation unit 103 generates an advertisement based on the providing place selected by the selection unit 101 and the parameter whose input is received by the input reception unit 102 (S3).

Since the advertisement generation system 100 according to the present disclosure generates the advertisement based on the selected providing place and the parameter whose input has been received, it is possible to more easily set the advertisement in the virtual space.

### Second Example Embodiment

Next, a second example embodiment will be described. The second example embodiment is a specific example of the first example embodiment described above.

### Advertisement System 10

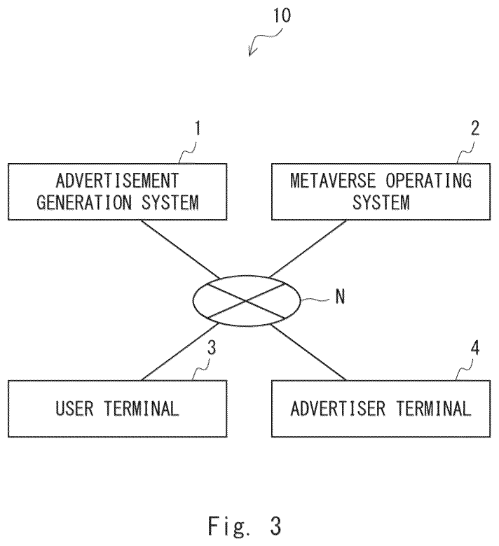

FIG. 3 is a block diagram illustrating an overall configuration of an advertisement system according to the present disclosure. The advertisement system 10 includes an advertisement generation system 1, a metaverse operating system 2, a user terminal 3, and an advertiser terminal 4.

Each of the advertisement generation system 1, the metaverse operating system 2, the user terminal 3, and the advertiser terminal 4 can communicate with each other via the network N. The number of each component included in the advertisement system 10 is not limited to the illustrated number. For example, the number of user terminals 3 may be two or more.

The advertisement system 10 is a system that provides an advertisement to a user in a virtual space. The user is a person who has entered the virtual space. Here, the virtual space is a virtual three-dimensional space constructed on a network such as the Internet by a computer. Specifically, the virtual space is generated by a computer and is expressed by three-dimensional computer graphics. The virtual space is configured to be able to provide an advertisement to the avatar present in the virtual space.

The virtual space may have a plurality of areas in which an avatar is movable. In each of the plurality of areas, an environment associated with a theme for each area can be constructed. For example, the plurality of areas is spaces set in a town, a suburb, a forest, a desert, a coastal area, an amusement park, an event venue, or the like. Theme of each area is not limited thereto.

Examples of the virtual space include a metaverse. The user enters the virtual space by using the avatar. Hereinafter, a description will be given by exemplifying a metaverse as the virtual space. For example, the advertisement system 10 provides a user who uses virtual reality (VR) goggles with a video of the metaverse. The present disclosure is not limited thereto, and the advertisement system 10 may provide a video to the user by using a technology such as augmented reality (AR). In that case, the user recognizes a specific place as an advertisement providing place via AR glasses or an AR recognition terminal.

The avatar mimics the user's actions. The user can operate the avatar via the user terminal 3 to perform a desired motion in the virtual space. The avatar is also generated by the computer and is expressed by three-dimensional computer graphics.

The advertisement system 10 provides an advertisement to the avatar in the virtual space to advertise a product or a service to the user associated with the avatar. Any genre of the advertisement is applied. Each configuration of the advertisement system 10 will be described below.

### User Terminal 3

The user terminal 3 is a smartphone, a personal computer (PC), VR goggles, or the like used by the user. The user terminal 3 may include a camera that captures an action of the user. The user terminal 3 may include various sensors that measure the visual line of the user, a heart rate, brain waves, and the like.

For example, the user terminal 3 measures the visual line of the user while the advertisement is displayed on the virtual space using any eye tracking technology. The user terminal 3 transmits a measurement result acquired by the measurement to the advertisement generation system 1 as visual line information. The visual line information may include, for example, an image around the user's eyeball, a direction of the user's visual line detected from the image, a position of the user's viewpoint, or the like. The visual line information may include a date and time at which these pieces of information are detected.

The user terminal 3 may determine whether the user has browsed the displayed advertisement based on the position of the viewpoint of the user. For example, in a case where the coordinates on a screen of the user terminal 3 on which the advertisement is displayed match the coordinates of the position of the viewpoint of the user, the user terminal 3 determines that the user has browsed the advertisement. The user terminal 3 may measure a time during which the user continuously browses the advertisement based on the position of the viewpoint of the user. The user terminal 3 may measure the number of times the user browses another place while the advertisement is displayed and the time thereof.

The user terminal 3 may include these determination results and measurement results in the visual line information and transmit the visual line information to the advertisement generation system 1. Alternatively, the user terminal 3 may transmit these pieces of information to the advertisement generation system 1 at any timing separately from the visual line information.

### Advertiser Terminal 4

The advertiser terminal 4 is a smartphone, a PC, or the like used by an advertiser. An advertiser is a person or organization that provides an advertisement within a metaverse. The advertiser terminal 4 receives an operation of the advertiser and transmits the received result to the advertisement generation system 1. For example, the advertiser terminal 4 is used by an advertiser to designate an advertisement providing place and an advertisement providing mode. The advertiser terminal 4 is used by the advertiser to confirm and accept the advertisement generated by the advertisement generation system 1.

The advertisement providing mode indicates how to provide the advertisement to the user. The advertisement providing mode includes, for example, information indicating whether the advertisement produces a visual effect, an auditory effect, or both. The advertisement may include only an image, may include only voice, or may include a combination of an image and voice.

Examples of the advertisement providing mode include an appearance of the advertisement, a timing of starting the provision of the advertisement, a timing of ending the provision of the advertisement, and the like. The appearance of the advertisement is, for example, a size, a type (shape), an advertisement text, a color, or the number of pixels of data of the advertisement. The advertisement providing mode may be fixed or variable. For example, the advertisement providing mode may be changed according to a situation of an advertisement providing place.

### Metaverse Operating System 2

The metaverse operating system 2 is a system that constructs a metaverse on a network N and operates the metaverse.

### Advertisement Generation System 1

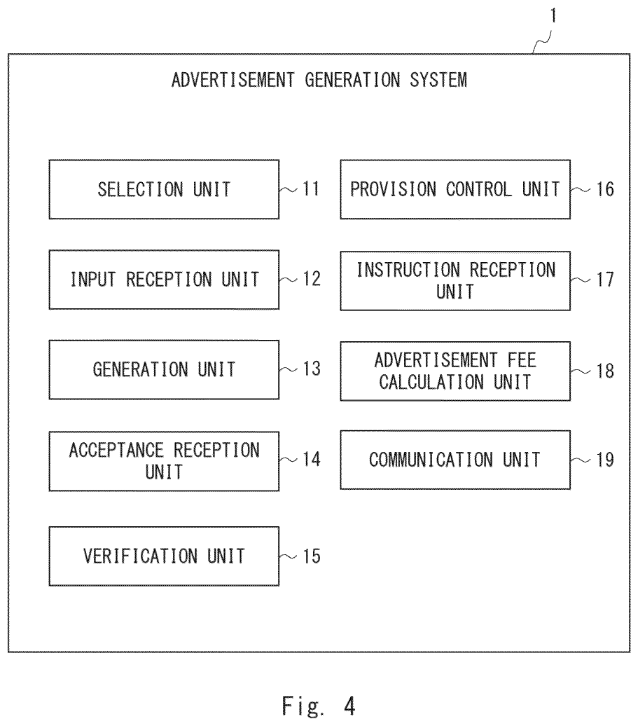

FIG. 4 is a block diagram illustrating a configuration of the advertisement generation system 1. The advertisement generation system 1 is an example of the advertisement generation system 100 described above. The advertisement generation system 1 is a system that supports generation of an advertisement by performing predetermined processing. The advertisement generation system 1 includes a selection unit 11, an input reception unit 12, a generation unit 13, an acceptance reception unit 14, a verification unit 15, a provision control unit 16, an instruction reception unit 17, an advertisement fee calculation unit 18, and a communication unit 19.

The selection unit 11 is an example of the selection unit 101 described above. The selection unit 11 selects an advertisement providing place in the virtual space. The selection unit 11 may automatically select the providing place according to a predetermined condition, or may receive an input from the advertiser and manually select the providing place. The selection unit 11 may extract a candidate for the providing place and present the candidate to the advertiser. In this case, the selection unit 11 selects the candidate selected from the advertiser as the advertisement providing place.

The selection unit 11 may select a providing place from among a plurality of preset advertisement spots in the virtual space. The advertisement spot is an example of a providing place. The advertisement spot indicates a target for which an advertisement can be placed in the virtual space. The selection unit 11 excludes an already used advertisement spot from a plurality of preset advertisement spots, and selects a providing place from among vacant advertisement spots. The present disclosure is not limited thereto, and the selection unit 11 may newly create an advertisement spot. The selection unit 11 may randomly select an advertisement spot.

The advertisement spot is provided, for example, in a target such as an object, a person, an area, a space, or an image in the virtual space. The advertisement spot may be a part of these targets. The advertisement spot is, for example, a predetermined area of a bulletin board provided in the virtual space. For example, the selection unit 11 may select an advertisement spot provided in a part of a still image displayed on the display in the virtual space as the providing place.

The selection unit 11 may select a moving image reproduced in the virtual space as the providing place. For example, the selection unit 11 selects an advertisement spot provided at a predetermined reproduction position in the moving image displayed on the display in the virtual space as the providing place.

As the providing place, not only a place associated with the real world but also a wall, air, on water, underwater, a floor, or the like in the virtual space may be selectable. As a result, the advertisement generation system 1 can provide an advertisement to a place that cannot be achieved by an advertisement in the real world. In a case where an advertisement or the like whose content changes depending on the viewing angle is used, the providing place may be selected in a range (angle at which the advertisement is visible from the avatar) visible from the avatar to which the advertisement is provided.

The providing place may be fixed or variable. For example, the providing place may be set within a predetermined distance (For example, 5 m) from a predetermined point. The providing place may not be limited to a specific area such as the advertisement spot described above. For example, in a case where an advertisement is output by voice, the entire virtual space may be selected as the providing place, or a predetermined area may be selected. As the providing place, an installation position of a voice output device (for example, a speaker) provided at a predetermined position in the virtual space may be selected.

The selection unit 11 may select a providing place where the advertisement is likely to be viewed according to the content of the advertisement included in the parameter received by the input reception unit 12. For example, the selection unit 11 selects an area of a theme associated with the content of the advertisement as the providing place.

For example, it is assumed that an advertisement for an automobile is provided. The selection unit 11 selects an area in which the advertisement for the automobile is more likely to be viewed. In this case, it is assumed that the advertisement is more likely to be viewed in an area of a town or a city than in an area of a desert or a forest. Therefore, the selection unit 11 selects an area themed on a town or a city. The selection unit 11 may select a place having a large number of avatars among the areas of the city.

For example, the selection unit 11 may receive selection of a city area from an advertiser and select the city area, or may present a plurality of city areas to the advertiser as candidates for a providing place. The selection unit 11 may add why the city areas are presented as candidates. As a result, the advertiser can easily select a providing place having a high advertising effect. The advertiser can prevent an undesired providing place from being selected.

The selection unit 11 may select a providing place related to a product or an advertisement. For example, it is assumed that an advertisement type of a shape of a float is selected in the input reception unit 12. In this case, the selection unit 11 selects a providing place of a theme related to the float. For example, the selection unit 11 may present various oceans, beaches, rivers, or the like in the virtual space to an advertiser as candidates for a providing place. In this way, the selection unit 11 can present a plurality of providing places related to the float to the advertiser.

The selection unit 11 may select a plurality of providing places. As a result, the generation unit 13 generates an advertisement associated with each of the plurality of providing places.

The selection unit 11 may select the providing place according to the advertisement fees. For example, the selection unit 11 may select a providing place where the higher the advertisement fee of the advertisement is, the more likely the advertisement is to be viewed. For example, the selection unit 11 selects a providing place having a large number of avatars as a providing place where the advertisement is likely to be viewed. For example, the selection unit 11 calculates a statistical value (for example, an average value, a median value, a variance, a standard deviation, or the like) of the number of avatars existing in a predetermined space, and specifies a providing place having a relatively large number of avatars based on the calculation result. The selection unit 11 may select a providing place having a high avatar density in a predetermined space. The selection unit 11 may determine whether the number or density of avatars is high by using a predetermined threshold.

The selection unit 11 may reflect date and time and seasonal characteristics in a statistical value. For example, it is assumed that the number of avatars is large around the sea in the summer (or daytime) and the number of avatars is small in the sea in the winter (or nighttime). The selection unit 11 can select a place where an increase in the number of avatars can be expected at the time of occurrence of a specific event as the providing place.

The selection unit 11 may select the providing place based on the number of visual lines of the user instead of or in addition to the number of avatars. For example, the selection unit 11 selects, as the providing place, a place where there are many visual lines always directed from the user. As a result, the selection unit 11 can select a providing place attracting user's attention.

For example, the selection unit 11 acquires the visual line information from the user terminal 3. Here, it is assumed that the visual line information includes at least the direction of the visual line of the user. The selection unit 11 selects a place where the number of visual lines of the user is a predetermined value or more as the providing place. The selection unit 11 does not select a place where the number of visual lines of the user is less than the predetermined value as the providing place. As a result, the selection unit 11 can select a place where there is a high possibility that the advertisement will be viewed as the providing place, and can prevent the selection unit from selecting a place where there is a low possibility that the advertisement will be viewed as the providing place.

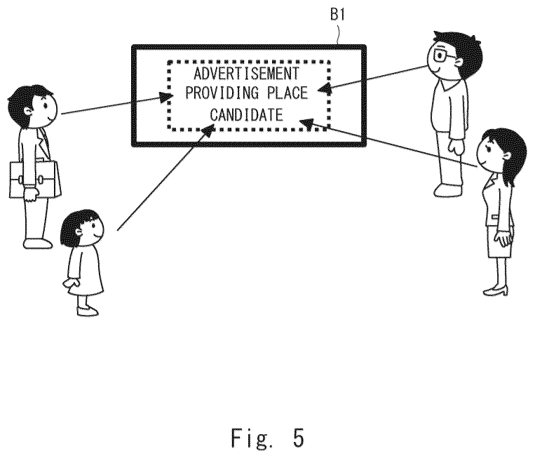

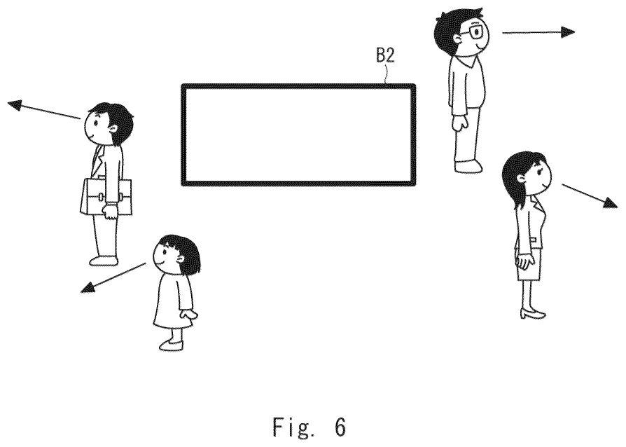

FIGS. 5 and 6 are diagrams illustrating an example in which a providing place is selected based on the number of visual lines of the user. In the example of FIG. 5, a bulletin board B1 in which the visual lines of users of a predetermined value or more are collected is illustrated. The selection unit 11 selects the bulletin board B1 as a candidate for an advertisement providing place. In the example of FIG. 6, a bulletin board B2 in which the visual lines of users of a predetermined value or more are not collected is illustrated. The selection unit 11 does not select the bulletin board B2 as a candidate for the advertisement providing place.

The selection unit 11 may select the providing place according to the attribute of the user associated with the avatar visiting the providing place. The attribute of the user is, for example, age, sex, occupation, preference, or hobby. The attribute of the user may be stored as attribute information in, for example, a storage unit (not illustrated) of the advertisement generation system 1 or the metaverse operating system 2. The attribute information may be managed in association with a user ID or the like for identifying the user.

The description will return to FIG. 4. The input reception unit 12 is an example of the input reception unit 102 described above. The input reception unit 12 receives an input of a parameter for setting an advertisement providing mode. The parameter is, for example, a size, a type (shape), an advertisement text, a color, or the number of pixels of data of the advertisement. Examples of the advertisement type include a bulletin board, a signboard, a balloon, a cloud, a cylinder, a sphere, a plane, a curved surface, and the like. The present disclosure is not limited thereto, and advertisements in various shapes may be used. For example, the advertisement type may be a poster posted on a bulletin board.

As the advertisement type, not only two-dimensional advertisements but also three-dimensional model advertisements may be used. For example, an advertisement type such as a truck traveling in the virtual space or a balloon flying in the virtual space may be used. By using the advertisement type of the three-dimensional model, the user can easily view the advertisement. The parameter may include information regarding arrangement of non-player characters (NPCs). The parameter may include information related to the motion of the NPC. The movement of the NPC is, for example, running, walking, jumping, or the like.

The size of the advertisement may be represented by a vertical length, a horizontal length, and a height (depth) of the advertisement, or may be represented by the number of pixels. The advertisement text is a sentence or a text indicating the content of the advertisement. The advertisement text is, for example, an explanation of a product or a service. The advertisement text may include characters to be emphasized or characters to be posted on the advertisement as attached information. The font, taste, and the like of the advertisement text may be selectable. The color of the advertisement may be selectable from a plurality of color variations. The color of the advertisement may be a single color or multiple colors. For example, a providing mode such as transition from a single color to multiple colors may be selectable.

An advertisement fee may be set according to each parameter. For example, the advertisement fee may be set in such a way as to increase as the numerical value of each parameter of the size, the sentence amount, the number of colors, or the number of pixels of the advertisement increases. Since the degree of freedom of the parameter becomes higher as the advertisement fee becomes higher, the advertiser can flexibly set the parameters such as the size and type of the advertisement according to the paid (bid) amount. The advertiser can increase the options regarding the advertisement providing mode according to a paid amount.

For example, the input reception unit 12 generates a display screen for inputting an advertisement providing mode, and causes the advertiser terminal 4 to display the display screen. The input reception unit 12 receives an input of the advertiser with respect to the display screen, and outputs the received result to the generation unit 13.

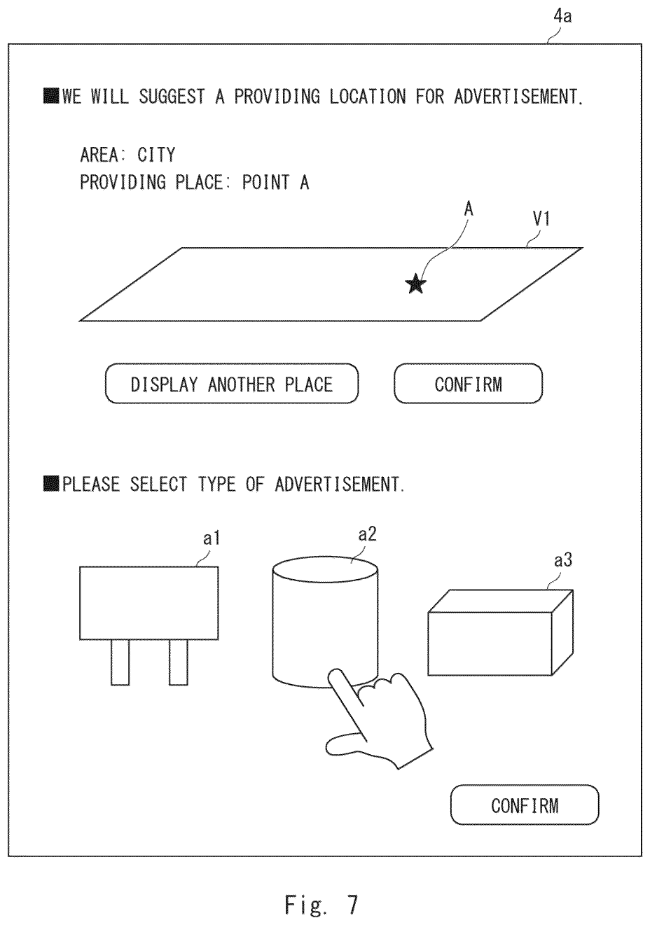

FIG. 7 is a diagram illustrating an example of a display screen 4a for selecting an advertisement providing place and an advertisement type. The display screen 4a is displayed on a display unit (not illustrated) of the advertiser terminal 4. In the example of FIG. 7, a point A of the city area is displayed as a candidate of the providing place. The point A is set on the ground surface v1 of the virtual space. In FIG. 7, three types a1 to a3 are displayed as advertisement types. The advertisement type a1 has a shape of a bulletin board. The advertisement type a2 has a cylindrical shape. The advertisement type a3 has a rectangular parallelepiped shape. The advertiser operates the advertiser terminal 4 to select an advertisement type.

For example, the advertiser presses a “confirm” button in a case where the presented place is determined as the advertisement providing place, and presses a “display another place” button in a case where the advertiser desires to present another candidate. The advertiser selects a desired advertisement type and presses a “confirm” button. Here, it is assumed that the advertiser determines to provide an advertisement at the point A of the presented city area and to generate an advertisement with the advertisement type a2.

The display screen 4a may be configured to be able to input more detailed parameters. For example, the display screen 4a may include an input field for inputting an advertisement text. The display screen 4a may include an input field for inputting a size, a color, the number of pixels, or the like of the advertisement. The display screen 4a receives an input of each parameter and outputs the parameter to the generation unit 13.

The input reception unit 12 may receive the input of the parameter within an appropriate range of the parameter set according to the providing place. For example, in a case where the number of pixels of the image of the advertisement is a predetermined value or more, there is a possibility that the advertisement cannot be appropriately displayed depending on the performance of the user terminal 3 or the like. Therefore, the input reception unit 12 may present the set range to the advertiser and prompt the advertiser to input a numerical value within the set range. The appropriate range of the number of pixels may be set using at least one of an upper limit value and a lower limit value of the number of pixels included in the image of the advertisement. The image of the advertisement may configure the entire advertisement or a part of the advertisement.

The input reception unit 12 may receive an input of an advertisement generated from one material. For example, the input reception unit 12 may receive selection of two-dimensional, three-dimensional, and NPC using a check box. In a case where the user desires to generate a plurality of advertisements from the same material, the user checks a plurality of check boxes.

The input reception unit 12 may receive inputs of a budget of an advertisement fee per day and attributes (for example, males in their twenties) of a target user.

The input reception unit 12 may support creation of a prompt in generating an advertisement. For example, the input reception unit 12 presents past prompts and successful examples of products (advertisements). The input reception unit 12 may cause the advertiser terminal 4 to display similarity (for example, the closeness of the category) between the past prompt and the input content of the user. As a result, the advertiser can grasp the prompt for efficiently generating the advertisement. A successful example may use an advertisement having a relatively high evaluation. For example, the input reception unit 12 may specify an advertisement evaluated at a predetermined value or more as a success example. The input reception unit 12 may support creation of a prompt in consideration of similarity of the attribute (for example, the industry type) of the advertiser.

The input reception unit 12 may receive an input of a simple sketch used for generating an advertisement. As a result, the generation unit 13 can generate an advertisement using the sketch.

The input reception unit 12 may receive an input of a moving image of a conversation scene between avatars. As a result, the generation unit 13 can generate an advertisement using the moving image of the conversation scene.

The description will return to FIG. 4. The generation unit 13 is an example of the generation unit 103 described above. The generation unit 13 generates an advertisement based on the providing place selected by the selection unit 11 and the parameter input by the input reception unit 12. For example, the generation unit 13 automatically generates an advertisement using artificial intelligence such as generative artificial intelligence (AI). The generation unit 13 generates an advertisement by designing, for example, a size, a typeface, an inclination, a color, or the like of characters of the advertisement text.

As a result, the advertiser can easily generate an advertisement without performing complicated setting. Therefore, the advertisement generation system 1 can lower a psychological hurdle for an advertiser to create an advertisement. The generation unit 13 may immediately provide the generated advertisement on the virtual space, or may provide the generated advertisement after acceptance of the advertiser is received as described later.

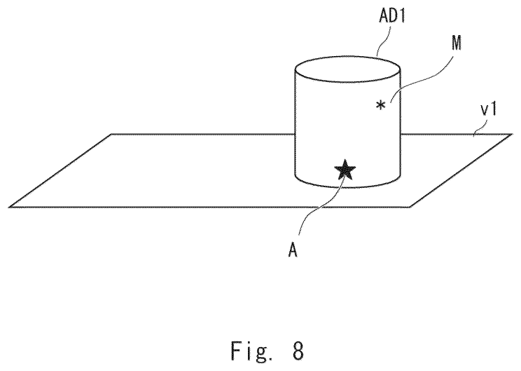

FIG. 8 is a diagram illustrating an example of an advertisement providing mode. Here, the advertisement AD1 of the advertisement type a2 is provided at the point A on the ground surface v1 of the virtual space according to the selection result on the display screen 4a of FIG. 7. For example, the generation unit 13 arranges the advertisement AD1 such that the center of the bottom surface of the advertisement AD1 coincides with the point A. As a result, the generation unit 13 provides the advertisement AD1 at the point A.

In a case of generating the advertisement using the artificial intelligence, the generation unit 13 may give a predetermined display indicating that the advertisement is generated by the artificial intelligence to the advertisement. The predetermined display mode may be any display mode. The predetermined display may be any display that can identify that the advertisement has been generated using artificial intelligence. For example, the generation unit 13 gives a predetermined display to the advertisement in a form such as a mark, a text, an icon, or a label.

In the example of FIG. 8, a mark M indicated by “*” is given to the advertisement AD1 as a predetermined display. The predetermined display is not limited to the “*” mark, and the generation unit 13 may appropriately provide any display as the predetermined display. For example, the generation unit 13 may select or generate a predetermined display according to the type or name of the generated AI for generating the advertisement, and give the display to the advertisement. The predetermined display may be based on a system name newly created using the generated AI. For example, the generation unit 13 gives a mark M in such a way as to be represented at a lower right position of the advertisement as viewed from the user. Any position of the mark M may be set. The generation unit 13 may prove that the advertisement AD1 is generated by artificial intelligence by assigning the mark M.

The generation unit 13 may first generate a provisional advertisement and finalize provision of the advertisement in a case where acceptance of the advertisement from the advertiser is received. For example, the generation unit 13 generates a provisional advertisement based on the providing place and the parameter. The generation unit 13 transmits the provisional advertisement to the advertiser terminal 4 via the communication unit 19, and requests the advertiser to confirm the provisional advertisement. In a case where the acceptance of the provisional advertisement is received by the acceptance reception unit 14, the generation unit 13 determines the provisional advertisement as an advertisement to be provided to the providing place.

The generation unit 13 may adjust the advertisement providing mode according to an instruction from the advertiser before the acceptance of the advertiser is received. For example, the advertiser instructs the generation unit 13 to correct the provisional advertisement requested to be confirmed via the advertiser terminal 4. For example, the advertiser instructs correction of a size, a color, a shape, an angle, a providing place, or the like of characters of the provisional advertisement. The generation unit 13 receives an instruction from the advertiser and corrects the advertisement providing mode according to the instruction. The generation unit 13 can customize the advertisement by slightly modifying the advertisement according to the desire of the advertiser.

The generation unit 13 may adjust the advertisement providing mode according to the advertisement fee of the advertisement. For example, the generation unit 13 adjusts the advertisement providing mode with a higher degree of freedom as the advertisement fee increases. The generation unit 13 adjusts the advertisement providing mode in such a way that the higher the advertisement fee, the greater the effect of the advertisement.

In a case of adjusting the provisional advertisement, the generation unit 13 transmits the adjusted provisional advertisement to the advertiser terminal 4 and requests confirmation of the advertisement again. The generation unit 13 may repeat the adjustment of the provisional advertisement until the approval of the advertiser is obtained. In a case where the advertiser accepts the provision of the advertisement, the advertiser transmits an acceptance to the advertisement generation system 1 via the advertiser terminal 4. In a case where the acceptance is received by the acceptance reception unit 14, the generation unit 13 confirms the provision of the advertisement.

In this way, the advertiser can instruct correction to the provisional advertisement before completion of the advertisement, instead of checking the advertisement generated by the advertisement generation system 1 afterwards. As a result, the advertiser can customize the automatically generated advertisement and generate a desired advertisement.

The generation unit 13 may transmit the generated advertisement data (for example, image data) to the advertiser terminal 4. Thus, the advertiser can use the advertisement data as a material.

The generation unit 13 may generate the advertisement using not only the specifically set parameter but also a predetermined template. As a result, the generation unit 13 can output a simplified advertisement. The advertiser can reduce time and effort for inputting parameters, and costs and time required for advertisement generation. Since the generated advertisement is relatively light as data, the advertiser can easily manage the data of the advertisement. Since such an advertisement is an advertisement familiar to the user, there is also an advantage that the user can easily grasp the main points of the advertisement.

The generation unit 13 may generate a collaboration advertisement (hereinafter, referred to as “collaborative advertisement”) for achieving collaboration with another existing advertisement as long as the content matches the another advertisement. For example, the generation unit 13 adds a new advertisement element (for example, an advertisement text or an image) to the existing advertisement without impairing the concept of the existing advertisement. For example, the generation unit 13 generates a collaborative advertisement in such a manner that a new flier enters the bulletin board. The number of advertisements targeted for collaboration is not limited to two, and may be three or more.

In a case where a collaborative advertisement is generated, it is necessary to obtain permission of an advertiser of an existing advertisement. The generation unit 13 may apply for the permission to the advertiser. The collaborative advertisement may be a collaborative advertisement having a master-subordinate relationship or a collaborative advertisement having a parallel relationship. If the advertiser of the existing advertisement permits, the advertisement generated by the generation unit 13 may have contents that do not match the contents of other advertisements.

In a case where a plurality of providing places is selected by the selection unit 11, the generation unit 13 generates an advertisement provided at each of the plurality of providing places. The generation unit 13 may generate the same advertisement provided at all of the plurality of providing places, or may generate different advertisements depending on the providing places.

In a case where the same advertisement is generated, the generation unit 13 may generate a greatest common divisor advertisement for a providing mode suitable for each providing place in consideration of situations of a plurality of providing places. For example, it is assumed that 10 providing places are selected in the selection unit 11. The generation unit 13 specifies a providing mode suitable for each of the 10 providing places. The generation unit 13 combines the providing modes of the 10 providing places under the AND condition to generate an advertisement satisfying the common condition. As a result, the generation unit 13 can generate a balanced advertisement as a whole according to the element of the providing mode common to the plurality of providing places.

In the above example, the generation unit 13 does not necessarily need to create advertisements associated with the 10 providing places. The generation unit 13 may select a providing place (for example, the density of the avatar is high, and an event is scheduled to be held in the future) assumed to have a high effect as an advertisement and generate only advertisements (for example, 8) of the selected providing places. The generation unit 13 may automatically select such a providing place, or may receive an instruction from an advertiser and select such a providing place.

The description will return to FIG. 4. The acceptance reception unit 14 receives acceptance of the provision of the advertisement from the advertiser. For example, the acceptance reception unit 14 receives the approval of the advertiser via the advertiser terminal 4. For example, the acceptance reception unit 14 generates a display screen for receiving the acceptance of the provisional advertisement, and transmits the display screen to the advertiser terminal 4 via the communication unit 19. The display screen may include, for example, contents of the provisional advertisement, a message of “Please check whether this advertisement is acceptable. ”, and an “acceptance”button.

The acceptance reception unit 14 causes the display unit of the advertiser terminal 4 to display the display screen. The acceptance reception unit 14 receives the acceptance or the non-acceptance from the advertiser terminal, and outputs the accepted result to the generation unit 13.

The verification unit 15 verifies the content of the advertisement generated by generation unit 13. For example, the verification unit 15 performs a fact check to verify whether the content of the advertisement is based on the fact. The verification unit 15 may verify whether rules relating to advertisements are observed. For example, the verification unit 15 may verify whether an advertisement related to alcoholic beverages, pharmaceuticals, or the like satisfies a predetermined standard defined by law. The verification unit 15 notifies the advertiser of the verification result. As a result, the verification unit 15 can feed back the verification result to the advertiser.

The provision control unit 16 controls the provision of the advertisement. The provision control unit 16 dynamically changes the advertisement providing mode, unlike the providing place and the parameter set by the selection unit 11 and the input reception unit 12. The control content described below may be designated by the advertiser as a part of the parameters received by the input reception unit 12. In the provision control unit 16, the input reception unit 12 may receive an instruction in such a way that the providing mode is automatically adjusted.

For example, the provision control unit 16 provides the advertisement in different providing modes according to the situation of the user viewing the advertisement. As a result, the provision control unit 16 can provide the advertisement such that different advertisements can be seen by users.

For example, the provision control unit 16 provides the advertisement at different timings according to the attribute of the user. For example, the provision control unit 16 provides the advertisement to the user U1 at timing T1, and provides the advertisement to the user U2 at timing T2. The timings T1 and T2 may be predetermined periods. For example, the provision control unit 16 varies the date and time, the time period, the day of the week, or the like at which the advertisement is provided according to the age, occupation, or the like of the user. As a result, the provision control unit 16 can effectively provide the advertisement at a timing suitable for the attribute of the user.

The provision control unit 16 may control whether to provide the advertisement according to the attribute of the user. For example, the attribute of the user may be information indicating whether the user is paying to disable the advertisement. Hereinafter, a user who is paying is referred to as a “paying user”, and a user who is not paying is referred to as a “non-paying user”.

The provision control unit 16 may not provide the advertisement to the paying user and may provide the advertisement to the non-paying user. As a result, the provision control unit 16 can control the provision of the advertisement such that, for example, even if the advertisement is provided to the same point A, the advertisement is invisible to the paying user U3 and the advertisement is visible to the non-paying user U4. As a result, it is possible to prevent an advertisement that the paying user does not desire to view from being provided.

The provision control unit 16 may provide the advertisement in a different providing mode according to an attribute other than whether the user is a paying user or a non-paying user. For example, the provision control unit 16 may control the provision of the advertisement in such a way that the advertisement X1 can be seen in a case where the user is male, and the advertisement X2 can be seen in a case where the user is female.

The provision control unit 16 may provide the advertisement in a different providing mode according to environmental information indicating an environment around the providing place. For example, the environmental information is advertisement provision date and time. For example, the provision control unit 16 provides the advertisement in a providing mode according to a time period such as morning, daytime, or night. The provision control unit 16 may determine the providing mode using a more detailed time period (for example, from 12:00 to 13:00). For example, in the case of night, the provision control unit 16 provides an advertisement at a place with a lot of light. In a case where the advertisement is of the firework type, the provision control unit 16 may display the advertisement in the sky area.

The environmental information may be weather around the providing place. The provision control unit 16 may provide the advertisement in a providing mode according to the weather such as sunny, cloudy, rainy, or snowy. For example, in a case where the weather is rainy, the provision control unit 16 provides the advertisement indoors.

The environmental information may be the number of avatars present around the providing place. For example, the provision control unit 16 determines whether the number of avatars is a predetermined value or more, and determines the providing mode according to the determination result. The provision control unit 16 may make the providing mode different between a case where the number of avatars is a predetermined value or more and a case where the number of avatars is less than the predetermined value. The provision control unit 16 may make the determination using the density of the avatar in the predetermined space.

Instead of or in addition to the number of avatars, the number of visual lines of the user may be used. The provision control unit 16 may provide the advertisement to a place where there are many visual lines always directed from the user. As a result, the provision control unit 16 can provide an advertisement to a place attracting user's attention.

The provision control unit 16 may stop providing the advertisement in a case where the number of visual lines of the user changes from a predetermined value or more to less than a predetermined value in a state where the advertisement is provided. As a result, in a case where the number of visual lines of the user decreases, the displayed advertisement disappears.

The provision control unit 16 may acquire data of the number of visual lines of the users who have gathered in the advertisement, for example, by time period or by place. The provision control unit 16 can collect data indicating in which time period and which place the most advertisements are viewed based on the acquired data. As a result, the data can be utilized in providing advertisements in the real world.

The environmental information may be information of an event occurring around the providing place. The provision control unit 16 may make the providing mode different between a case where the event occurs and a case where the event does not occur. In the region where the event occurs, since the number of avatars increases, it is assumed that the advertisement viewing increases. For example, in a case where a specific event is held, the provision control unit 16 preferentially provides an advertisement of an advertiser who has presented an expensive advertisement fee. For example, the provision control unit 16 may adjust the advertisement providing mode by increasing the size and volume of the advertisement as the advertisement fee is higher.

Since the above-described environmental information is an example, the environmental information may include other information. A plurality of pieces of information among the above-described examples may be included in the environmental information.

The provision control unit 16 may control the provision of the advertisement according to the instruction received by the instruction reception unit 17. In a case where an instruction to skip or stop the provision of the advertisement is received, the provision control unit 16 skips or stops the provision of the advertisement. The provision control unit 16 may feed back information related to the skipped or stopped advertisement to the advertiser. For example, the provision control unit 16 feeds back a timing of skipping or stopping, the number of views of the advertisement, and the like.

The provision control unit 16 may adjust the advertisement providing mode according to the position of the avatar in such a way as to increase the visibility of the advertisement. For example, the provision control unit 16 controls an angle, a height, brightness, or the like at which the advertisement is displayed. The provision control unit 16 adjusts the providing mode in such a way that the user can easily visually recognize the advertisement. For example, the provision control unit 16 adjusts the color of the advertisement in such a way that the visibility of the advertisement is enhanced according to the color of the background in a case where the advertisement is viewed from the avatar. As a result, the user can easily view the advertisement.

The provision control unit 16 may control the provision of the advertisement in such a way as to provide the advertisement in a case where the avatar approaches within a predetermined distance from the advertisement providing place. The provision control unit 16 pops the advertisement with the approach of the avatar as a trigger. As a result, it is possible to prevent the world view of the virtual space from being impaired by viewing the advertisement from a long distance. Since the provision control unit 16 can provide the advertisement in a space-saving manner, it is possible to secure a large number of advertisement providing places.

In a case where the advertisement is provided in the moving image, the provision control unit 16 may provide the advertisement at a timing at which a predetermined phrase is detected in the moving image. The predetermined phrase delimits the flow of the moving image. For example, the provision control unit 16 detects, as the predetermined phrase, a phrase such as “I will summarize,”“that is to say,”or “that's all”from the voice in the moving image. The provision control unit 16 inserts the advertisement at a timing immediately after such a phrase. With the above operation, it is possible to reduce the sense of discomfort in a case where the moving image reproduction is interrupted by the advertisement.

The provision control unit 16 may provide the advertisement at the position of the boundary between the area before the movement and the area after the movement at the timing at which the avatar moves to different areas. As a result, at a timing at which the avatar moves between areas, the provision control unit 16 can effectively provide an advertisement related to the area before or after the movement.

The provision control unit 16 may control the provision of the advertisement using a mechanism of a retargeting advertisement. For example, the provision control unit 16 provides a plurality of advertisement samples to the user, and tracks subsequent behavior of the user. The provision control unit 16 may provide only the advertisement having a good reaction of the user again.

In a case where a plurality of advertisements is generated by the generation unit 13, the provision control unit 16 may control the provision of each advertisement of the plurality of advertisements. For example, the provision control unit 16 may provide each of the advertisements provided at a plurality of providing places at the same timing or at different timings. For example, the provision control unit 16 may provide 10 advertisements simultaneously or at different timings.

The description will return to FIG. 4. The instruction reception unit 17 receives an instruction to skip or stop the provision of the advertisement. The instruction reception unit 17 may receive an instruction from the user via the user terminal 3 or may receive an instruction according to the motion of the avatar in the virtual space. The instruction reception unit 17 outputs the received instruction to the provision control unit 16.

In a case where the user does not desire to view the advertisement, the user gives an instruction to skip the provided advertisement or an instruction to stop the advertisement. For example, the instruction reception unit 17 accepts an instruction to skip an advertisement in response to an avatar waving a hand in front of a bulletin board on which the advertisement is posted, in the advertisement replaced with the elapse of a predetermined time.

An upper limit may be set for the number of times of skipping. For example, in a case where an advertisement is skipped a predetermined number of times, the instruction reception unit 17 may not receive an instruction of skipping until a predetermined time elapses. As a result, the user can select and view the advertisement that the user desires to view. The advertisement generation system 1 may acquire data of a skipped advertisement or an advertisement that is viewed for a long time.

The advertisement fee calculation unit 18 calculates an advertisement fee. For example, the advertisement fee calculation unit 18 calculates the advertisement fee of the advertisement based on at least one of the number of views, the size, and the providing place of the provided advertisement. The advertisement fee is set higher as the number of views is larger. The advertisement fees are set higher as the size of the advertisement is larger. The advertisement fees are set higher as the location of the providing place is better. The location may be set based on the number of avatars coming in and out, the popularity of the area, and the like.

The communication unit 19 is a communication interface for performing wired or wireless communication. The communication unit 19 transmits and receives data to and from the metaverse operating system 2, the user terminal 3, and the advertiser terminal 4.

The configuration of advertisement system 10 has been described above. The configuration of the above-described advertisement system 10 is merely an example, and can be appropriately changed. For example, in a case where some or all of the components of the advertisement generation system 1 are achieved by a plurality of information processing devices, circuits, and the like, the plurality of information processing devices, circuits, and the like may be arranged in a centralized manner or in a distributed manner. For example, each of the information processing devices, circuitry, or the like may be implemented in the form of a client server system, a cloud computing system, or the like in which they are connected to each other through a communication network. The function of the advertisement generation system 1 may be provided in a software as a service (SaaS) format.

In the above description, the advertisement generation system 1 and the metaverse operating system 2 are described as separate systems, but the present disclosure is not limited thereto. For example, the metaverse operating system 2 may include a part or all of the configuration of the advertisement generation system 1.

### Processing of Advertisement Generation System 1

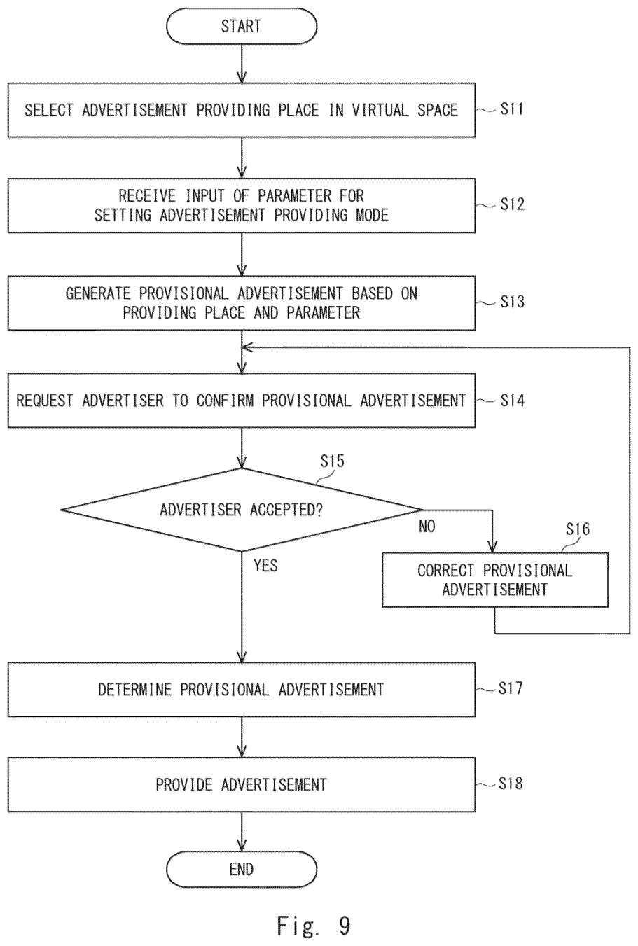

Next, processing performed by the advertisement generation system 1 will be described with reference to FIG. 9. FIG. 9 is a flowchart illustrating processing of the advertisement generation system 1.

First, the selection unit 11 selects an advertisement providing place in the virtual space (S11). Next, the input reception unit 12 receives an input of a parameter for setting an advertisement providing mode (S12).

Here, an example in which step S12 is performed after step S11 will be described, but step S12 may be performed first, and then step S11 may be performed. For example, the selection unit 11 may select the providing place in step S11 based on the parameter received in step S12. For example, in a case where the advertisement type of the shape of the float is selected, the selection unit 11 may present to the advertiser a sea, a seashore, a river, or the like suitable for the advertisement of the shape of the float as a candidate for the providing place.

Subsequently, the generation unit 13 generates a provisional advertisement based on the providing place and the parameter (S13). The generation unit 13 requests the advertiser to confirm the provisional advertisement (S14). The acceptance reception unit 14 determines whether the advertiser has accepted the content of the provisional advertisement (S15). In a case where it is determined that the advertiser has not accepted the provisional advertisement (NO in S15), the generation unit 13 corrects the provisional advertisement (S16). The generation unit 13 returns to step S14 and repeats the processing.

In a case where it is determined that the advertiser has accepted the advertisement (YES in S15), the generation unit 13 determines the provisional advertisement as the advertisement to be provided to the providing place (S17). The generation unit 13 provides the advertisement at the providing place (S18).

Although not illustrated, the verification unit 15 may verify whether the content of the advertisement is based on the fact and notify the advertiser of the verification result. As described above, in each step of selecting a providing place, inputting a parameter, and providing an advertisement, various settings may be performed with different degrees of freedom according to, for example, the level of advertisement fees.

As described above, in the advertisement system 10 according to the present disclosure, the advertisement generation system 1 selects the advertisement providing place in the virtual space, receives the input of the parameter for setting the advertisement providing mode, and generates the advertisement based on the providing place and the parameter. As a result, the advertisement generation system 1 can more easily set an advertisement in the virtual space.

The advertisement generation system 1 can customize an advertisement by adjusting a providing place and a parameter according to a desire of an advertiser that provides the advertisement and a situation of a user who views the advertisement. As a result, the advertisement generation system 1 can generate and provide an effective advertisement having a high possibility of being viewed.

### Configuration Example of Hardware

Each functional configuration unit of the advertisement generation system 100, the advertisement generation system 1, the metaverse operating system 2, the user terminal 3, and the advertiser terminal 4 (hereinafter, referred to as an “advertisement generation system 100 and the like”) may be achieved by hardware (for example, a hard-wired electronic circuit or the like) that achieves each functional configuration unit, or may be achieved by a combination of hardware and software (for example, a combination of an electronic circuit and a program that controls the electronic circuit or the like). Hereinafter, a case where each functional configuration unit of the advertisement generation system 100 and the like is achieved by a combination of hardware and software will be further described.

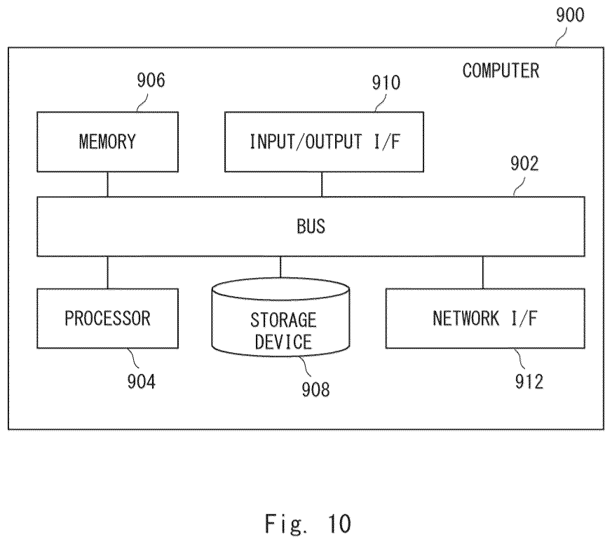

FIG. 10 is a block diagram illustrating a hardware configuration of a computer 900 that implements the advertisement generation system 100 and the like. The computer 900 may be a dedicated computer designed to achieve the advertisement generation system 100 and the like, or may be a general-purpose computer. The computer 900 may be a portable computer such as a smartphone or a tablet terminal.

For example, by installing a predetermined application in the computer 900, each function of the advertisement generation system 100 and the like is achieved in the computer 900. The application is configured by a program for achieving a functional configuration unit of the advertisement generation system 100 and the like.

The computer 900 includes a bus 902, a processor 904, a memory 906, a storage device 908, an input/output interface 910, and a network interface 912. The bus 902 is a data transmission path for the processor 904, the memory 906, the storage device 908, the input/output interface 910, and the network interface 912 to transmit and receive data to and from each other. However, a method for connecting the processor 904 and the like to each other is not limited to the bus connection.

The processor 904 is various processors such as a central processing unit (CPU), a graphics processing unit (GPU), a field-programmable gate array (FPGA), or a quantum processor (a quantum computer control chip). The memory 906 is a main storage device achieved by using a random access memory (RAM) or the like. The storage device 908 is an auxiliary storage device achieved by using a hard disk, a solid state drive (SSD), a memory card, a read only memory (ROM), or the like.

The input/output interface 910 is an interface that connects the computer 900 to an input/output device. For example, an input device such as a keyboard and an output device such as a display device are connected with the input/output interface 910.

The network interface 912 is an interface that connects the computer 900 to a network. The network may be a local area network (LAN) or a wide area network (WAN).

The storage device 908 stores a program for achieving each functional configuration unit such as the advertisement generation system 100 (a program for achieving the above-described application). The processor 904 reads the program into the memory 906 and executes the program to implement each functional component of the advertisement generation system 100 and the like.

Each of the processors executes one or more programs including an instruction group for causing a computer to perform an algorithm that has been described with reference to the drawings. The program includes an instruction group (or software codes) for causing the computer to perform one or more functions that have been described in the example embodiments in a case where the program is read by the computer. The program may be stored in various types of non-transitory computer readable media or tangible storage media. By way of example, and not limitation, non-transitory computer readable media or tangible storage media include RAM, ROM, flash memory, SSD or other memory technology, CD-ROM, digital versatile disc (DVD), Blu-ray® disk or other optical disk storage, magnetic cassettes, magnetic tape, magnetic disk storage, or other magnetic storage devices. The program may also be transmitted in the various types of transitory computer readable media or a communication medium. By way of example, and not limitation, the transitory computer readable medium or the communication medium includes an electric signal, an optical signal, an acoustic signal, or any other form of propagation signal.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the example embodiments described above may be described as, but are not limited to, the following Supplementary Notes.

### Supplementary Note 1

An advertisement generation system including:
a selection unit that selects an advertisement providing place in a virtual space,
an input reception unit that receives an input of a parameter for setting an advertisement providing mode, and
a generation unit that generates the advertisement based on the providing place and the parameter.

### Supplementary Note 2

The advertisement generation system according to Supplementary Note 1, further including an acceptance reception unit that receives acceptance of the provision of the advertisement from an advertiser, in which
the generation unit generates a provisional advertisement based on the providing place and the parameter, and determines the provisional advertisement as an advertisement to be provided to the providing place in a case where acceptance of the provisional advertisement is received.

### Supplementary Note 3

The advertisement generation system according to Supplementary Note 1 or 2, in which
the generation unit adjusts the advertisement providing mode according to at least one of an instruction from the advertiser and an advertisement fee of the advertisement.

### Supplementary Note 4The advertisement generation system according to any one of Supplementary Notes 1 to 3, in which

the selection unit selects the providing place where the advertisement is more likely to be viewed in accordance with content of the advertisement included in the parameter.

### Supplementary Note 5

The advertisement generation system according to any one of Supplementary Notes 1 to 4, in which the selection unit selects the providing place where the higher the advertisement fee of the advertisement is, the more likely the advertisement is to be viewed.

### Supplementary Note 6The advertisement generation system according to any one of Supplementary Notes 1 to 5, in which

the input reception unit receives the input of the parameter within an appropriate range of the parameter set according to the providing place.

### Supplementary Note 7

The advertisement generation system according to Supplementary Note 6, in which
the appropriate range is set using at least one of an upper limit value and a lower limit value of the number of pixels included in the image of the advertisement.

### Supplementary Note 8

The advertisement generation system according to any one of Supplementary Notes 1 to 7, in which
in a case of generating the advertisement using artificial intelligence, the at least one processor gives a predetermined display indicating that the advertisement is generated by the artificial intelligence to the advertisement.

### Supplementary Note 9

The advertisement generation system according to any one of Supplementary Notes 1 to 8, further including a verification unit that verifies a content of the advertisement, in which
the verification unit verifies whether the content of the advertisement is based on a fact, and notifies the advertiser of a verification result.

### Supplementary Note 10

The advertisement generation system according to any one of Supplementary Notes 1 to 9, further including a provision control unit that controls provision of the advertisement, in which
the provision control unit provides the advertisement in different providing modes according to a situation of a user viewing the advertisement.

### Supplementary Note 11

The advertisement generation system according to Supplementary Note 10, in which
the provision control unit provides the advertisement at a different timing according to an attribute of the user.

### Supplementary Note 12

The advertisement generation system according to Supplementary Note 10 or 11, in which
the provision control unit provides the advertisement in a different providing mode according to environmental information indicating an environment around the providing place, and
the environmental information includes at least one of a provision date and time of the advertisement, weather around the providing place, the number of avatars existing around the providing place, and information on an event occurring around the providing place.

### Supplementary Note 13

The advertisement generation system according to any one of Supplementary Notes 10 to 12, further including an instruction reception unit that receives an instruction to skip or stop the provision of the advertisement, in which
the provision control unit controls the provision of the advertisement according to the received instruction.

### Supplementary Note 14

The advertisement generation system according to any one of Supplementary Notes 10 to 13, in which
the provision control unit adjusts the advertisement providing mode according to a position of the avatar in such a way as to increase visibility of the advertisement.

### Supplementary Note 15

The advertisement generation system according to any one of Supplementary Notes 10 to 14, in which
the selection unit selects a moving image to be reproduced in the virtual space as the providing place, and
the provision control unit provides the advertisement at a timing at which a predetermined phrase is detected in the moving image.

### Supplementary Note 16

The advertisement generation system according to any one of Supplementary Notes 10 to 15, in which
the virtual space includes a plurality of areas in which the avatar is movable, and
the provision control unit provides the advertisement at a position of a boundary between an area before movement and an area after movement at a timing at which the avatar moves to a different area.

### Supplementary Note 17

The advertisement generation system according to any one of Supplementary Notes 1 to 16, further including
an advertisement fee calculation unit that calculates an advertisement fee of the advertisement based on at least one of the number of views, a size, and a providing place of the provided advertisement.

### Supplementary Note 18

An advertisement generation method including:
selecting an advertisement providing place in a virtual space;
receiving an input of a parameter for setting an advertisement providing mode; and
generating an advertisement based on the providing place and the parameter.

### Supplementary Note 19

A program causing a computer to execute:
selecting an advertisement providing place in a virtual space;
receiving an input of a parameter for setting an advertisement providing mode; and
generating the advertisement based on the providing place and the parameter.

Some or all of the elements (for example, configurations and functions) described in Supplementary Notes 2 to 17 dependent on Supplementary Note 1 can also depend on Supplementary Notes 18 and 19 in the same dependency relationship as Supplementary Notes 2 to 17. Some or all of the elements that have been described in any supplementary note are applicable to various types of hardware, software, recording means for recording software, systems, and methods.

What is claimed is:

1. An advertisement generation system comprising:
at least one memory storing instructions; and
at least one processor configured to execute the instructions to:
select an advertisement providing place in a virtual space;
receive an input of the parameter for setting an advertisement providing mode; and
generate the advertisement based on the providing place and the parameter.

2. The advertisement generation system according to claim 1, wherein
the at least one processor is further configured to execute the instructions to:
receive acceptance of the provision of the advertisement from an advertiser; and
generate a provisional advertisement based on the providing place and the parameter, and determine the provisional advertisement as an advertisement to be provided to the providing place in a case where acceptance of the provisional advertisement is received.

3. The advertisement generation system according to claim 1, wherein
the at least one processor is further configured to execute the instructions to
adjust the advertisement providing mode according to at least one of an instruction from the advertiser and an advertisement fee of the advertisement.

4. The advertisement generation system according to claim 1, wherein
the at least one processor is further configured to execute the instructions to
select the providing place where the advertisement is more likely to be viewed in accordance with content of the advertisement included in the parameter.

5. The advertisement generation system according to claim 1, wherein
the at least one processor is further configured to execute the instructions to
select the providing place where the higher the advertisement fee of the advertisement is, the more likely the advertisement is to be viewed.

6. The advertisement generation system according to claim 1, wherein
the at least one processor is further configured to execute the instructions to
receive the input of the parameter within an appropriate range of the parameter set according to the providing place.

7. The advertisement generation system according to claim 6, wherein
the appropriate range is set using at least one of an upper limit value and a lower limit value of the number of pixels included in the image of the advertisement.

8. The advertisement generation system according to claim 1, wherein
the at least one processor is further configured to execute the instructions to
in a case of generating the advertisement using artificial intelligence, give a predetermined display indicating that the advertisement is generated by the artificial intelligence to the advertisement.

9. The advertisement generation system according to claim 1, wherein
the at least one processor is further configured to execute the instructions to:
verify the content of the advertisement; and
verify whether content of the advertisement is based on a fact, and notify an advertiser of a verification result.

10. The advertisement generation system according to claim 1, wherein
the at least one processor is further configured to execute the instructions to:
control provision of the advertisement; and
provide the advertisement in a different providing mode according to a situation of a user viewing the advertisement.

11. The advertisement generation system according to claim 10, wherein
the at least one processor is further configured to execute the instructions to
provide the advertisement at a different timing according to an attribute of the user.

12. The advertisement generation system according to claim 10, wherein
the at least one processor is further configured to execute the instructions to
provide the advertisement in a different providing mode according to environmental information indicating an environment around the providing place, and
the environmental information includes at least one of a provision date and time of the advertisement, weather around the providing place, the number of avatars existing around the providing place, and information on an event occurring around the providing place.

13. The advertisement generation system according to claim 10, wherein
the at least one processor is further configured to execute the instructions to:
receive an instruction to skip or stop the provision of the advertisement; and
control the provision of the advertisement according to the received instruction.

14. The advertisement generation system according to claim 10, wherein
the at least one processor is further configured to execute the instructions to
adjust the advertisement providing mode according to a position of the avatar in such a way as to increase visibility of the advertisement.

15. The advertisement generation system according to claim 10, wherein
the at least one processor is further configured to execute the instructions to:
select a moving image to be reproduced in the virtual space as the providing place; and
provide the advertisement at a timing at which a predetermined phrase is detected in the moving image.

16. The advertisement generation system according to claim 10, wherein
the virtual space includes a plurality of areas in which the avatar is movable, and
the at least one processor is further configured to execute the instructions to
provide the advertisement at a position of a boundary between an area before movement and an area after movement at a timing at which the avatar moves to a different area.

17. The advertisement generation system according to claim 1, wherein
the at least one processor is further configured to execute the instructions to
calculate an advertisement fee of the advertisement based on at least one of the number of views, a size, and a providing place of the provided advertisement.

18. An advertisement generation method comprising:
selecting an advertisement providing place in a virtual space;
receiving an input of a parameter for setting an advertisement providing mode; and
generating an advertisement based on the providing place and the parameter.

19. A non-transitory computer readable medium storing a program for causing a computer to execute:
selecting an advertisement providing place in a virtual space;
receiving an input of a parameter for setting an advertisement providing mode;
generating the advertisement based on the providing place and the parameter.
